(19) United States
(12) Patent Application Publication
(10) Pub. No.: US 2022/0063639 A1
(43) Pub. Date: Mar. 3, 2022

(54) METHOD, APPARATUS, AND COMPUTER PROGRAM PRODUCT FOR PREDICTING AUTONOMOUS TRANSITION REGIONS USING HISTORICAL INFORMATION

(71) Applicant: HERE GLOBAL B.V., Eindhoven (NL)

(72) Inventors: Leon Stenneth, Chicago, IL (US); Jerome Beaurepaire, Berlin (DE); Jeremy Michael Young, Chicago, IL (US)

(21) Appl. No.: 17/122,477

(22) Filed: Dec. 15, 2020

Related U.S. Application Data
(60) Provisional application No. 63/071,184, filed on Aug. 27, 2020.

(51) Int. Cl. B60W 50/00; G06N 5/04; G06N 20/00; B60W 60/00; G01C 21/34; G01C 21/36

(52) U.S. Cl. CPC B60W 50/0097; G06N 5/04; G06N 20/00; B60W 2556/10; G01C 21/3407; G01C 21/3626; B60W 60/001

(57) ABSTRACT

A method, apparatus and computer program product are provided for predicting autonomous transition regions using historical information. In this regard, historical autonomous transition data is accessed. The historical autonomous transition data is associated with vehicles that transition from respective autonomous levels while traveling along one or more road segments associated with a first geographic area. Furthermore, one or more features of the historical autonomous transition data associated with the first geographic area is identified. A machine learning model is then trained based on the one or more features associated with the first geographic area.

### CROSS-REFERENCE TO RELATED APPLICATIONS

This application claims the benefit of U.S. Provisional Application No. 63/071,184, filed Aug. 27, 2020, the entire contents of which are incorporated herein by reference.

### TECHNOLOGICAL FIELD

An example embodiment of the present disclosure generally relates to autonomous driving for vehicles and, more particularly, to a method, apparatus and computer program product for predicting autonomous transition regions using historical information.

### BACKGROUND

Vehicles are being built with more and more sensors to assist with autonomous driving and/or other vehicle technologies. Generally, sensors of a vehicle related to autonomous driving capture imagery data and/or radar data to assist with the autonomous driving. For instance, image sensors and Light Distancing and Ranging (LiDAR) sensors are popular sensor types for identifying objects along a road segment and establishing the safe path of traversal for a vehicle driving autonomously. Autonomous driving capabilities of vehicles are increasing toward full automation (e.g. Level 5 autonomy) with zero human interaction. However, there are numerous challenges related to autonomous driving capabilities of vehicles.

### BRIEF SUMMARY

A method, apparatus and computer program product are provided in order to predict autonomous transition regions using historical information. For instance, in one or more embodiments, method, apparatus and computer program product are provided in order to predict where a vehicle is likely to be transitioned from one level of autonomy to another level of autonomy. As such, precision and/or confidence of autonomous driving capabilities for a vehicle can be improved. Furthermore, improved navigation of a vehicle, improved route guidance for a vehicle, improved semi-autonomous vehicle control, and/or improved fully autonomous vehicle control can be provided.

In an example embodiment, a computer-implemented method is provided for predicting autonomous transition regions using historical information. The computer-implemented method includes accessing historical autonomous transition data associated with vehicles that transition from respective autonomous levels while traveling along one or more road segments associated with a first geographic area. The computer-implemented method also includes identifying one or more features of the historical autonomous transition data associated with the first geographic area. Furthermore, the computer-implemented method includes training a machine learning model based on the one or more features associated with the first geographic area. In an example embodiment, the computer-implemented method also includes predicting autonomous transition data for a second geographic area based on the machine learning model associated with the first geographic area. In an example embodiment, the predicting the autonomous transition data for the second geographic area includes predicting one or more autonomous transition regions for the second geographic area based on the machine learning model associated with the first geographic area.

In an example embodiment, the accessing the historical autonomous transition data includes accessing vehicle context data associated with a reason for a change in respective autonomous levels for the vehicles. In another example embodiment, the accessing the historical autonomous transition data includes accessing one or more indications of a decrease in a strength of a communication signal associated with the vehicles while traveling along the one or more road segments. In another example embodiment, the accessing the historical autonomous transition data includes accessing one or more indications that the one or more road segments associated with the vehicles satisfy a defined criterion associated with a particular road condition. In another example embodiment, the accessing the historical autonomous transition data includes accessing sensor data in response to a change in respective autonomous levels for the vehicles. In another example embodiment, the accessing the historical autonomous transition data includes accessing environmental data associated with a reason for a change in respective autonomous levels for the vehicles.

In another example embodiment, the identifying the one or more features comprises identifying a feature associated with a distance between a cellular base station and a road segment from the one or more road segments associated with the first geographic area. In this example embodiment, the training the machine learning model includes training the machine learning model based on the feature.

In another example embodiment, the identifying the one or more features comprises identifying a feature associated with a measure of a strength of a communication signal associated with the vehicles while traveling along a road segment of the one or more road segments associated with the first geographic area. In this example embodiment, the training the machine learning model includes training the machine learning model based on the feature.

In another example embodiment, the identifying the one or more features comprises identifying a feature associated with presence of a point of interest along a road segment of the one or more road segments associated with the first geographic area. In this example embodiment, the training the machine learning model includes training the machine learning model based on the feature.

In another example embodiment, the identifying the one or more features comprises identifying a feature associated with a road condition for a road segment of the one or more road segments associated with the first geographic area. In this example embodiment, the training the machine learning model includes training the machine learning model based on feature.

In another example embodiment, the identifying the one or more features comprises identifying a feature associated with a road segment of the one or more road segments associated with the first geographic area. In this example embodiment, the training the machine learning model includes training the machine learning model based on the feature.

In another example embodiment, the computer-implemented method also includes causing, via an electronic interface, rendering of data generated by the machine learning model. In another example embodiment, the computer-implemented method also includes facilitating routing of a vehicle based on the machine learning model. In another example embodiment, the computer-implemented method also includes causing rendering of a navigation route via a map display based on the machine learning model.

In another example embodiment, an apparatus is configured to predict autonomous transition regions using historical information. The apparatus includes processing circuitry and at least one memory including computer program code instructions that are configured to, when executed by the processing circuitry, cause the apparatus to access historical autonomous transition data associated with vehicles that transition from respective autonomous levels while traveling along one or more road segments associated with a first geographic area. The computer program code instructions are also configured to, when executed by the processing circuitry, cause the apparatus to identify one or more features of the historical autonomous transition data associated with the first geographic area. The computer program code instructions are also configured to, when executed by the processing circuitry, cause the apparatus to train a machine learning model based on the one or more features associated with the first geographic area. In an example embodiment, the computer program code instructions are also configured to, when executed by the processing circuitry, cause the apparatus to predict autonomous transition data for a second geographic area based on the machine learning model associated with the first geographic area.

In another example embodiment, the computer program code instructions are also configured to, when executed by the processing circuitry, cause the apparatus to identify a feature associated with a distance between a cellular base station and a road segment from the one or more road segments associated with the first geographic area. In this example embodiment, the computer program code instructions are also configured to, when executed by the processing circuitry, cause the apparatus to train the machine learning model based on the feature.

In another example embodiment, the computer program code instructions are also configured to, when executed by the processing circuitry, cause the apparatus to identify a feature associated with a measure of a strength of a communication signal associated with the vehicles while traveling along a road segment of the one or more road segments associated with the first geographic area. In this example embodiment, the computer program code instructions are also configured to, when executed by the processing circuitry, cause the apparatus to train the machine learning model based on the feature.

In another example embodiment, the computer program code instructions are also configured to, when executed by the processing circuitry, cause the apparatus to identify a feature associated with presence of a point of interest along a road segment of the one or more road segments associated with the first geographic area. In this example embodiment, the computer program code instructions are also configured to, when executed by the processing circuitry, cause the apparatus to train the machine learning model based on the feature.

In another example embodiment, the computer program code instructions are also configured to, when executed by the processing circuitry, cause the apparatus to identify a feature associated with a road condition for a road segment of the one or more road segments associated with the first geographic area. In this example embodiment, the computer program code instructions are also configured to, when executed by the processing circuitry, cause the apparatus to train the machine learning model based on the feature.

In another example embodiment, the computer program code instructions are also configured to, when executed by the processing circuitry, cause the apparatus to identify a feature associated with a pedestrian traffic condition for a road segment of the one or more road segments associated with the first geographic area. In this example embodiment, the computer program code instructions are also configured to, when executed by the processing circuitry, cause the apparatus to train the machine learning model based on the feature.

In another example embodiment, a computer program product is provided to predict autonomous transition regions using historical information. The computer program product includes at least one non-transitory computer readable storage medium having computer-executable program code instructions stored therein with the computer-executable program code instructions including program code instructions configured, upon execution, to access historical autonomous transition data associated with vehicles that transition from respective autonomous levels while traveling along one or more road segments associated with a first geographic area. The computer-executable program code instructions are also configured to identify one or more features of the historical autonomous transition data associated with the first geographic area. Furthermore, the computer-executable program code instructions are configured to train a machine learning model based on the one or more features associated with the first geographic area. In an example embodiment, the computer-executable program code instructions are also configured to predict autonomous transition data for a second geographic area based on the machine learning model associated with the first geographic area.

In another example embodiment, an apparatus is provided that includes means for predicting autonomous transition regions using historical information. The apparatus of this example embodiment also includes means for accessing historical autonomous transition data associated with vehicles that transition from respective autonomous levels while traveling along one or more road segments associated with a first geographic area. The apparatus of this example embodiment also includes means for identifying one or more features of the historical autonomous transition data associated with the first geographic area. The apparatus of this example embodiment also includes means for training a machine learning model based on the one or more features associated with the first geographic area. In an example embodiment, the apparatus of this example embodiment also includes means for predicting autonomous transition data for a second geographic area based on the machine learning model associated with the first geographic area.

In an example embodiment, the means for accessing the historical autonomous transition data includes means for accessing vehicle context data associated with a reason for a change in respective autonomous levels for the vehicles. In another example embodiment, the means for accessing the historical autonomous transition data includes means for accessing one or more indications of a decrease in a strength of a communication signal associated with the vehicles while traveling along the one or more road segments. In another example embodiment, the means for accessing the historical autonomous transition data includes means for accessing one or more indications that the one or more road segments associated with the vehicles satisfy a defined criterion associated with a particular road condition. In another example embodiment, the means for accessing the historical autonomous transition data includes means for accessing sensor data in response to a change in respective autonomous levels for the vehicles.

In another example embodiment, the means for identifying the one or more features includes means for identifying a feature associated with a distance between a cellular base station and a road segment from the one or more road segments associated with the first geographic area. In this example embodiment, the means for training the machine learning model includes means for training the machine learning model based on the feature.

In another example embodiment, the means for identifying the one or more features includes means for identifying a feature associated with a measure of a strength of a communication signal associated with the vehicles while traveling along a road segment of the one or more road segments associated with the first geographic area. In this example embodiment, the means for training the machine learning model includes means for training the machine learning model based on the feature.

In another example embodiment, the means for identifying the one or more features includes means for identifying a feature associated with presence of a point of interest along a road segment of the one or more road segments associated with the first geographic area. In this example embodiment, the means for training the machine learning model includes means for training the machine learning model based on the feature.

In another example embodiment, the means for identifying the one or more features includes means for identifying a feature associated with a road condition for a road segment of the one or more road segments associated with the first geographic area. In this example embodiment, the means for training the machine learning model includes means for training the machine learning model based on the feature.

In another example embodiment, the means for identifying the one or more features includes means for identifying a feature associated with a pedestrian traffic condition for a road segment of the one or more road segments associated with the first geographic area. In this example embodiment, the means for training the machine learning model includes means for training the machine learning model based on the feature.

In another example embodiment, the apparatus of this example embodiment also includes means for causing, via an electronic interface, rendering of data generated by the machine learning model. In another example embodiment, the apparatus of this example embodiment also includes means for facilitating routing of a vehicle based on the machine learning model. In another example embodiment, the apparatus of this example embodiment also includes means for causing rendering of a navigation route via a map display based on the machine learning model.

In an example embodiment, a computer-implemented method is provided for predicting autonomous transition regions using historical information. The computer-implemented method includes determining one or more features associated with one or more first vehicles traveling along a road segment associated with a first geographic area. The computer-implemented method also includes predicting, using a machine learning model that receives the one or more features, whether the road segment comprises an autonomous transition area in which a particular number of vehicles are transitioned from respective autonomous levels. In this example embodiment, the machine learning model is trained based on historical autonomous transition data associated with one or more second vehicles that are transitioned from respective autonomous levels while traveling along one or more road segments within a second geographic area, different than the first geographic area.

In another example embodiment, an apparatus is configured to predict autonomous transition regions using historical information. The apparatus includes processing circuitry and at least one memory including computer program code instructions that are configured to, when executed by the processing circuitry, cause the apparatus to determine one or more features associated with one or more first vehicles traveling along a road segment associated with a first geographic area. The computer program code instructions are also configured to, when executed by the processing circuitry, cause the apparatus to predict, using a machine learning model that receives the one or more features, whether the road segment comprises an autonomous transition area in which a particular number of vehicles are transitioned from respective autonomous levels. In this example embodiment, the machine learning model is trained based on historical autonomous transition data associated with one or more second vehicles that are transitioned from respective autonomous levels while traveling along one or more road segments within a second geographic area, different than the first geographic area.

In another example embodiment, a computer program product is provided to predict autonomous transition regions using historical information. The computer program product includes at least one non-transitory computer readable storage medium having computer-executable program code instructions stored therein with the computer-executable program code instructions including program code instructions configured, upon execution, to determine one or more features associated with one or more first vehicles traveling along a road segment associated with a first geographic area. The computer-executable program code instructions are also configured to predict, using a machine learning model that receives the one or more features, whether the road segment comprises an autonomous transition area in which a particular number of vehicles are transitioned from respective autonomous levels. In this example embodiment, the machine learning model is trained based on historical autonomous transition data associated with one or more second vehicles that are transitioned from respective autonomous levels while traveling along one or more road segments within a second geographic area, different than the first geographic area.

In another example embodiment, an apparatus is provided that includes means for predicting autonomous transition regions using historical information. The apparatus of this example embodiment also includes means for determining one or more features associated with one or more first vehicles traveling along a road segment associated with a first geographic area. The apparatus of this example embodiment also includes means for predicting, using a machine learning model that receives the one or more features, whether the road segment comprises an autonomous transition area in which a particular number of vehicles are transitioned from respective autonomous levels. In this example embodiment, the machine learning model is trained based on historical autonomous transition data associated with one or more second vehicles that are transitioned from respective autonomous levels while traveling along one or more road segments within a second geographic area, different than the first geographic area.

### BRIEF DESCRIPTION OF THE DRAWINGS

Having thus described certain embodiments of the disclosure in general terms, reference will now be made to the accompanying drawings, which are not necessarily drawn to scale, and wherein:

FIG. 1 is a block diagram of a system including an apparatus for predicting autonomous transition regions using historical information in accordance with one or more example embodiments of the present disclosure;

FIG. 2 is a flowchart illustrating operations performed, such as by the apparatus of FIG. 1, in order to provide for predicting autonomous transition regions using historical information in accordance with one or more example embodiments of the present disclosure;

FIG. 3 illustrates a map divided into autonomous transition regions in accordance with one or more example embodiments of the present disclosure;

FIG. 4 illustrates a vehicle with respect to a road segment in accordance with one or more example embodiments of the present disclosure;

FIG. 5 illustrates exemplary training data in accordance with one or more example embodiments of the present disclosure;

FIG. 6 illustrates other exemplary training data in accordance with one or more example embodiments of the present disclosure;

FIG. 7 illustrates exemplary feature data in accordance with one or more example embodiments of the present disclosure;

FIG. 8 is a block diagram of a system to facilitate generation of map data in accordance with one or more example embodiments of the present disclosure; and

FIG. 9 is an example embodiment of an architecture specifically configured for implementing embodiments described herein.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure can be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms can be used interchangeably to refer to data capable of being transmitted, received and/or stored in accordance with embodiments of the present disclosure. Thus, use of any such terms should not be taken to limit the spirit and scope of embodiments of the present disclosure.

A vehicle can become disengaged from an autonomous driving level due to, for example, environmental conditions, vehicle capabilities, sensor failures, software versions for components of a vehicle, hardware versions for components of a vehicle, sensor configurations for a vehicle, etc. To address these and/or other issues, a method, apparatus and computer program product are provided in accordance with an example embodiment in order to predict autonomous transition regions using historical information. In an embodiment, data can be collected from vehicles (e.g., autonomous driving vehicles) to facilitate mapping areas (e.g., road segments) along with a calculated likelihood that a level of autonomous driving will be possible or not for the areas. Accordingly, with this information, prediction as to whether a vehicle can successfully drive autonomously can be improved. Furthermore, in certain embodiments, navigation guidance for a vehicle can be re-routed to a route associated with an improved likelihood of driving autonomously. According to one or more embodiments, it can be determined when a level of autonomous driving mode for a vehicle is changed. In response to the change in the level of autonomous driving mode, data associated with the vehicle can collected. The collected data can include, for example, a vehicle make for the vehicle, a vehicle model for the vehicle, a previous autonomous level for the vehicle, a current autonomous level for the vehicle, a location of the vehicle during the change in the level of autonomous driving mode, a decision time of the vehicle associated with a decision to initiate the change in the level of autonomous driving mode, an execution time of the vehicle associated with execution of the change in the level of autonomous driving mode, version information for autonomous driving software and/or hardware employed by the vehicle, a reason for the change in the level of autonomous driving mode for the vehicle, and/or other information associated with the vehicle. In certain embodiments, data associated with multiple vehicles in an area can be collected via crowdsourcing to provide improved autonomous driving predictions for the area.

According to one or more embodiments, the data associated with the vehicles can be uploaded to a mapping server. Furthermore, the data from the vehicles can be aggregated into information to facilitate mapping and/or generating patterns for changes in autonomous driving modes for vehicles. In certain embodiments, an autonomous driving mode value can be mapped onto a road network and/or a road lane network. For example, in certain embodiments, an autonomous driving mode value can correspond to a number between 0-1 that corresponds to a percentage change of likelihood to demonstrate a particular autonomous level prediction. In certain embodiments, an autonomous driving mode value can be mapped by level of defined autonomy such as, for example, Level 0 that corresponds to no automation, Level 1 that corresponds to driver assistance, Level 2 that corresponds to partial automation, Level 3 that corresponds to conditional automation, Level 4 that corresponds to high automation, Level 5 that corresponds to full automation, and/or another sub-level associated with a degree of autonomous driving. In certain embodiments, different map layers can correspond to different levels of autonomous driving. Additionally, in certain embodiments, a map layer can be generated based on vehicle data such as, for example, a particular make/model of a vehicle, particular autonomous driving capabilities for a vehicle, other vehicle data, etc.

According to one or more embodiments, autonomous transition regions for a geographic can be predicted using historical information from one or more other geographic areas. For instance, in one or more embodiments, historical data related to autonomous transition regions in a first area (e.g., a first city) can be determined. Furthermore, in a second area (e.g., a second city) where autonomous vehicles have not yet been deployed, autonomous transition patterns associated with the first area (e.g., the first city) can be employed to predict which areas in the second area (e.g., the second city) will become autonomous transition regions for autonomous vehicles. In one or more embodiments, for each autonomous transition region in the first area, information related to one or more autonomous level transition reasons (e.g., a reason why autonomous vehicles changed respective autonomous levels) can be determined. The autonomous level transition reason can be a reason for a vehicle to transition to a different level of defined autonomy. In an embodiment, the autonomous level transition reason can be a reason that a vehicle disengages from a particular level of defined autonomy. In another embodiment, the autonomous level transition reason can be a reason that a vehicle engages into a particular level of defined autonomy. The autonomous level transition reason can include, for example, a decrease in communication signal strength for a vehicle (e.g. loss of a 5G signal employed by a vehicle), a road condition (e.g., road construction, high pedestrian traffic, etc.) being present at a road segment associated with a vehicle, a particular environmental condition (e.g., a particular weather condition, etc.) present at a road segment associated with a vehicle, reduced visibility distance for a vehicle due to a particular environmental condition, sensor limitations of a vehicle, another type of reason, etc. In one or more embodiments, a training data set can be determined based on the historical data related to autonomous transition regions in the first area. In one or more embodiments, a feature in the training dataset can be associated with a reason for an autonomous level being changed for a vehicle. In one or more embodiments, the training data set can additionally include historical information for other regions in the first area that are not autonomous transition regions. In certain embodiments, a designer of an autonomous vehicle infrastructure can employ the prediction to provide informed decisions regarding autonomous driving in the second area such as, for example, to determine where to allow autonomous transition regions in the second area and/or to determine where to avoid autonomous transition regions in the second area.

Accordingly, prediction of autonomous transition regions using historical information can be employed to provide improved autonomous driving and/or vehicle localization for a vehicle. Moreover, prediction of autonomous transition regions using historical information can provide additional dimensionality and/or advantages for one or more sensors of a vehicle. Prediction of autonomous transition regions using historical information can also provide a low cost and/or efficient solution for improved autonomous driving and/or vehicle localization for a vehicle. Computational resources for improved autonomous driving and/or vehicle localization can also be conserved. Prediction of autonomous transition regions using historical information can also provide a cost effective and/or efficient solution for improved autonomous driving and/or vehicle localization. Computational resources for improved autonomous driving and/or vehicle localization utilizing an automated driving capability map index for vehicles can also be relatively limited in order to allow the computational resources to be utilized for other purposes. Prediction of autonomous transition regions using historical information may additionally facilitate improved navigation of a vehicle, improved route guidance for a vehicle, improved semi-autonomous vehicle control, and/or improved fully autonomous vehicle control.

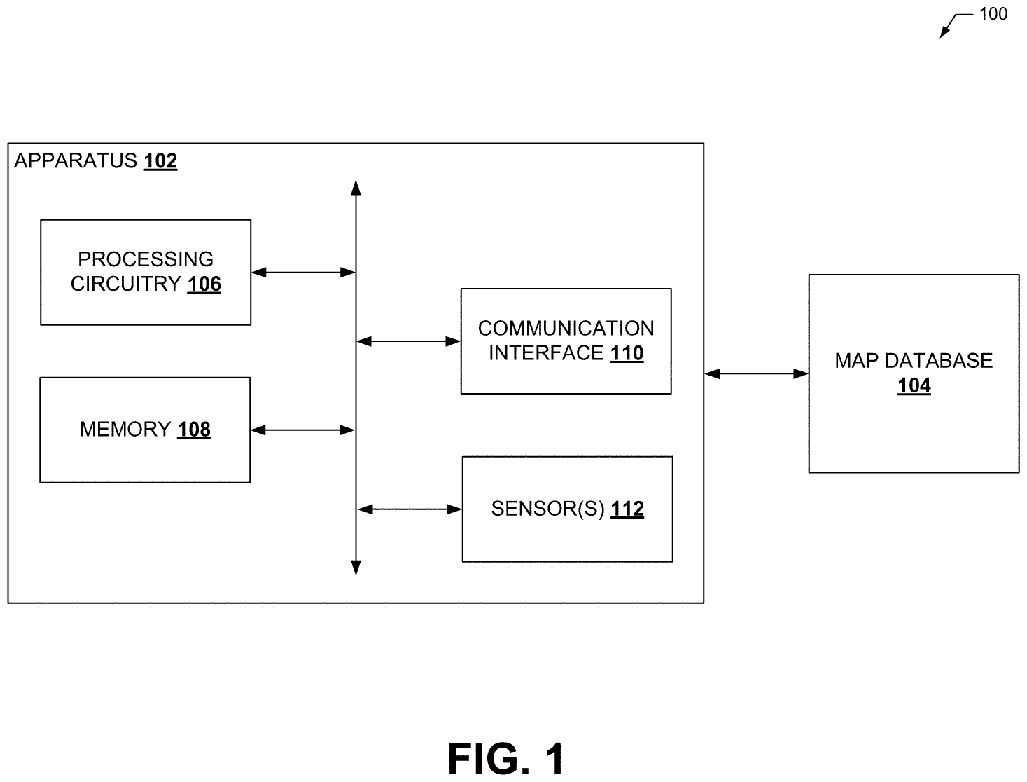

With reference to FIG. 1, a system 100 configured to predict autonomous transition regions using historical information is depicted, in accordance with one or more embodiments of the present disclosure. In the illustrated embodiment, the system 100 includes an apparatus 102 and a map database 104. As described further below, the apparatus 102 is configured in accordance with an example embodiment of the present disclosure to assist navigation of a vehicle and/or to autonomous driving for a vehicle. The apparatus 102 can be embodied by any of a wide variety of computing devices including, for example, a computer system of a vehicle, a vehicle system of a vehicle, a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System module (ADAS of a vehicle), or any other type of computing device carried by or remote from the vehicle including, for example, a server or a distributed network of computing devices.

In an example embodiment where some level of vehicle autonomy is involved, the apparatus 102 can be embodied or partially embodied by a computing device of a vehicle that supports safety-critical systems such as the powertrain (engine, transmission, electric drive motors, etc.), steering (e.g., steering assist or steer-by-wire), and/or braking (e.g., brake assist or brake-by-wire). However, as certain embodiments described herein may optionally be used for map generation, map updating, and map accuracy confirmation, other embodiments of the apparatus may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems. Regardless of the type of computing device that embodies the apparatus 102, the apparatus 102 of an example embodiment includes, is associated with or otherwise is in communication with processing circuitry 106, memory 108 and optionally a communication interface 110.

In some embodiments, the processing circuitry 106 (and/or co-processors or any other processors assisting or otherwise associated with the processing circuitry 106) can be in communication with the memory 108 via a bus for passing information among components of the apparatus 102. The memory 108 can be non-transitory and can include, for example, one or more volatile and/or non-volatile memories. In other words, for example, the memory 108 may be an electronic storage device (for example, a computer readable storage medium) comprising gates configured to store data (for example, bits) that can be retrievable by a machine (for example, a computing device like the processing circuitry 106). The memory 108 can be configured to store information, data, content, applications, instructions, or the like for enabling the apparatus 100 to carry out various functions in accordance with an example embodiment of the present disclosure. For example, the memory 108 can be configured to buffer input data for processing by the processing circuitry 106. Additionally or alternatively, the memory 108 can be configured to store instructions for execution by the processing circuitry 106.

The processing circuitry 106 can be embodied in a number of different ways. For example, the processing circuitry 106 may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 106 can include one or more processing cores configured to perform independently. A multi-core processor can enable multiprocessing within a single physical package. Additionally or alternatively, the processing circuitry 106 can include one or more processors configured in tandem via the bus to enable independent execution of instructions, pipelining and/or multithreading.

In an example embodiment, the processing circuitry 106 can be configured to execute instructions stored in the memory 108 or otherwise accessible to the processing circuitry 106. Alternatively or additionally, the processing circuitry 106 can be configured to execute hard coded functionality. As such, whether configured by hardware or software methods, or by a combination thereof, the processing circuitry 106 can represent an entity (for example, physically embodied in circuitry) capable of performing operations according to an embodiment of the present disclosure while configured accordingly. Thus, for example, when the processing circuitry 106 is embodied as an ASIC, FPGA or the like, the processing circuitry 106 can be specifically configured hardware for conducting the operations described herein. Alternatively, as another example, when the processing circuitry 106 is embodied as an executor of software instructions, the instructions can specifically configure the processing circuitry 106 to perform the algorithms and/or operations described herein when the instructions are executed. However, in some cases, the processing circuitry 106 can be a processor of a specific device (for example, a computing device) configured to employ an embodiment of the present disclosure by further configuration of the processor by instructions for performing the algorithms and/or operations described herein. The processing circuitry 106 can include, among other things, a clock, an arithmetic logic unit (ALU) and/or one or more logic gates configured to support operation of the processing circuitry 106.

The apparatus 102 of an example embodiment can also optionally include the communication interface 110 that can be any means such as a device or circuitry embodied in either hardware or a combination of hardware and software that is configured to receive and/or transmit data from/to other electronic devices in communication with the apparatus 102, such as the map database 104 that stores data (e.g., map data, historical autonomous transition data, feature data, autonomous level data, location data, geo-referenced locations, time data, timestamp data, temporal data, vehicle data, vehicle version data, software version data, hardware version data, vehicle speed data, distance data, vehicle context data, statistical data, etc.) generated and/or employed by the processing circuitry 106. Additionally or alternatively, the communication interface 110 can be configured to communicate in accordance with various wireless protocols including, but not limited to, Global System for Mobile Communications (GSM), Long Term Evolution (LTE), fifth-generation (5G), etc. In this regard, the communication interface 110 can include, for example, an antenna (or multiple antennas) and supporting hardware and/or software for enabling communications with a wireless communication network. In this regard, the communication interface 110 can include, for example, an antenna (or multiple antennas) and supporting hardware and/or software for enabling communications with a wireless communication network. Additionally or alternatively, the communication interface 110 can include the circuitry for interacting with the antenna(s) to cause transmission of signals via the antenna(s) or to handle receipt of signals received via the antenna(s). In some environments, the communication interface 110 can alternatively or also support wired communication and/or may alternatively support vehicle to vehicle or vehicle to infrastructure wireless links.

In certain embodiments, the apparatus 102 can be equipped or associated with one or more sensors 112, such as one or more GPS sensors, one or more accelerometer sensors, one or more LiDAR sensors, one or more radar sensors, one or more gyroscope sensors, one or more ultrasonic sensors, one or more infrared sensors and/or one or more other sensors. Any of the one or more sensors 112 may be used to sense information regarding movement, positioning, and/or orientation of the apparatus 102 for use in navigation assistance and/or autonomous vehicle control, as described herein according to example embodiments.

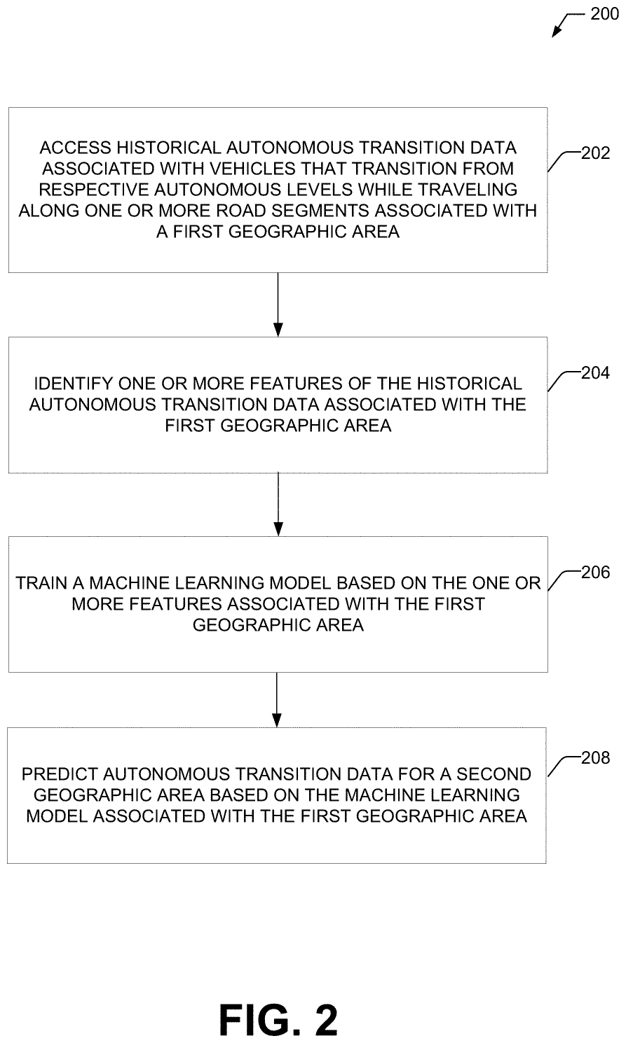

FIG. 2 illustrates a flowchart depicting a method 200 according to an example embodiment of the present disclosure. It will be understood that each block of the flowchart and combination of blocks in the flowchart can be implemented by various means, such as hardware, firmware, processor, circuitry, and/or other communication devices associated with execution of software including one or more computer program instructions. For example, one or more of the procedures described above can be embodied by computer program instructions. In this regard, the computer program instructions which embody the procedures described above can be stored, for example, by the memory 108 of the apparatus 102 employing an embodiment of the present disclosure and executed by the processing circuitry 106. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Referring now to FIG. 2, the operations performed, such as by the apparatus 102 of FIG. 1, in order to provide for predicting autonomous transition regions using historical information, in accordance with one or more embodiments of the present disclosure. As shown in block 202 of FIG. 2, the apparatus 102 includes means, such as the processing circuitry 106, the memory 108, or the like, configured to access historical autonomous transition data associated with vehicles that transition from respective autonomous levels while traveling along one or more road segments associated with a first geographic area. For instance, in an embodiment, the historical autonomous transition data can be stored in the memory 108, the map database 108, and/or another datastore accessible by the apparatus 102. The first geographic area can be, for example, at least a portion of a geographic region, at least a portion of a city, at least a portion of a town, at least a portion of a neighborhood, at least a portion of a state, at least a portion of a country, etc. Furthermore, in one or more embodiments, the first geographic area can include one or more spatial reference points. A spatial reference point can be a portion of a road segment and/or portion of the first geographic area. For example, in an embodiment, a spatial reference point can be a location point on a road segment. In another embodiment, a reference point can be a geometric shape that represents at least a portion of a road segment. In yet another embodiment, a spatial reference point can be a geometric shape that represents an area that includes one or more road segments. In a non-limiting example, a spatial reference point can be a tile (e.g., a grid cell, a square area, a rectangular area, etc.) associated with one or more portions of one or more road segments and/or the first geographic area. For example, a spatial reference point can be a tile (e.g., a grid cell, a square area, a rectangular area, etc.) associated with a 500 meter by 500 meter geographic area. In another non-limiting example, a spatial reference point can be a polygon associated with one or more portions of one or more road segments and/or a geographic area. In yet another non-limiting example, a spatial reference point can be a line associated with one or more portions of one or more road segments and/or a geographic area. However, it is to be appreciated that, in one or more embodiments, a spatial reference point can be another geometric shape associated with one or more portions of one or more road segments and/or the first geographic area.

In various embodiments, a spatial reference point can be an autonomous transition region. For example, a spatial reference point can be a region of one or more road segments where an autonomous level for vehicles is likely to change. In certain embodiments, the apparatus 102, such as the processing circuitry 106, can be configured to designate a cluster as a spatial reference point in response to a determination that a minimum number of vehicles is within the spatial reference point or within a certain distance from the spatial reference point. Furthermore, the apparatus 102, such as the processing circuitry 106, can be configured to employ criterion associated with distance to determine a spatial reference point. For example, the apparatus 102, such as the processing circuitry 106, can be configured to initially set a spatial reference point to correspond to a certain size (e.g., 30 meters in size). Furthermore, in certain embodiments, the apparatus 102, such as the processing circuitry 106, can be configured to dynamically alter a size of a spatial reference point based on a number of vehicles in the autonomous transition region and/or other conditions associated with the autonomous transition region.

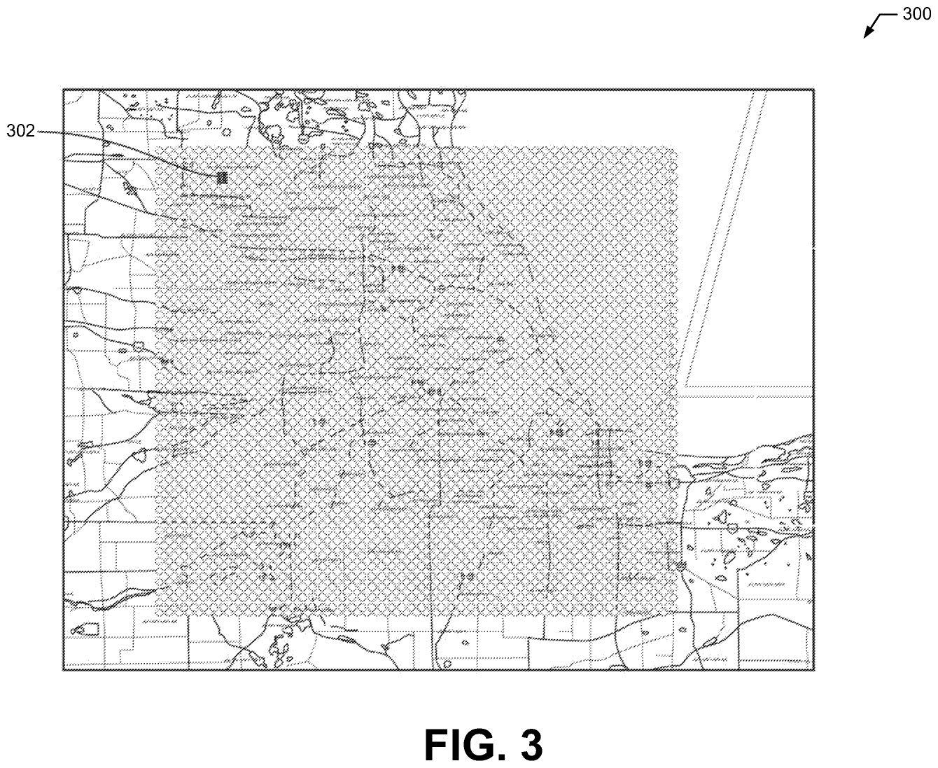

FIG. 3 illustrates a map 300 divided into autonomous transition regions. For example, the map 300 includes at least an autonomous transition region 302. In one or more embodiments, the autonomous transition region 302 can correspond to a spatial reference point. In an embodiment, the autonomous transition region 302 can be a tile cell or a grid cell. In a non-limiting example, the autonomous transition region 302 can be a 2 kilometer by 2 kilometer tile cell. However, it is to be appreciated that the autonomous transition region 302 can be a different shape and/or a different size. In one or more embodiments, the apparatus 102, such as the processing circuitry 106, can be configured to determine and/or access historical autonomous transition data for the autonomous transition region 302. In one or more embodiments, the apparatus 102, such as the processing circuitry 106, can be configured to determine and/or access historical autonomous transition data for the autonomous transition region 302 per time epoch (e.g., every hour, every 15 minutes, etc.). For example, in certain embodiments, the autonomous transition region 302 can be active at time 5 but not active at time t+delta.

In one or more embodiments, the historical autonomous transition data can provide an indication regarding an autonomous level transition reason for vehicles that transition from respective autonomous levels while traveling along the one or more road segments associated with the first geographic area. The autonomous level transition reason can be, for example, one or more reasons why the vehicles transitioned from respective autonomous levels while traveling along the one or more road segments during one or more intervals of time. In an embodiment, the autonomous level transition reason can be one or more reasons why one or more of the vehicles disengaged from particular levels of defined autonomy while traveling along the one or more road segments associated with the first geographic area. Additionally or alternatively, the autonomous level transition reason can be one or more reasons why one or more of the vehicles engaged into particular levels of defined autonomy while traveling along the one or more road segments associated with the first geographic area.

In one or more embodiments, the autonomous level transition reason can include a decrease in communication signal strength (e.g. loss of a 5G signal) for one or more of the vehicles traveling along the one or more road segments associated with the first geographic area. The autonomous level transition reason can additionally or alternatively include a road condition (e.g., road construction, high pedestrian traffic, etc.) being present at the one or more road segments while one or more of the vehicles traveled along the one or more road segments associated with the first geographic area. The autonomous level transition reason can additionally or alternatively include a particular environmental condition (e.g., a particular weather condition, etc.) present at the one or more road segments while one or more of the vehicles traveled along the one or more road segments associated with the first geographic area. Furthermore, it is to be appreciated that, in one or more embodiments, the autonomous level transition reason can additionally or alternatively include a different type of reason associated with transition of vehicles from respective autonomous levels while traveling along the one or more road segments associated with the first geographic area.

In one or more embodiments, the apparatus 102, such as the processing circuitry 106, can be configured to generate at least a portion of the historical autonomous transition data based on autonomous level data and/or location data thereof associated with the vehicles traveling along the one or more road segments associated with the first geographic area. For example, in one or more embodiments, the apparatus 102, such as the processing circuitry 106, can be configured to identify the autonomous level data based on a change in an autonomous level for the vehicles traveling along the one or more road segments associated with the first geographic area. In one or more embodiments, the apparatus 102, such as the processing circuitry 106, can be configured to receive the autonomous level data and/or the location data (e.g., from the vehicles traveling along the one or more road segments associated with the first geographic area) in response to the change in the autonomous level for the vehicles traveling along the one or more road segments associated with the first geographic area. In one or more embodiments, the apparatus 102, such as the processing circuitry 106, can be configured to receive the historical autonomous transition data (e.g., the historical autonomous transition data generated based on the autonomous level data and/or the location data) from a database. In various embodiments, the change in the autonomous level for the vehicle can be determined and/or initiated by a processor (e.g., the processing circuitry 106 or other processing circuitry) of the vehicles traveling along the one or more road segments associated with the first geographic area. The change in the autonomous level for the vehicles traveling along the one or more road segments associated with the first geographic area can be, for example, an increase in the autonomous level for the vehicles or a decrease in the autonomous level for the vehicles. For example, the change in the autonomous level for the vehicles traveling along the one or more road segments associated with the first geographic area can be a transition of an autonomous level for the vehicles.

In one or more embodiments, the historical autonomous level data can include an autonomous level indicative of a level of defined autonomy (e.g., a degree of autonomous driving) associated with the vehicles traveling along the one or more road segments associated with the first geographic area. For instance, the historical autonomous level data can include an indication of a particular autonomous level for the vehicles associated with the change in the autonomous level. In certain embodiments, the historical autonomous level data can include a first indication of a first autonomous level for a vehicle prior to the change in the autonomous level and a second indication of a second autonomous level for a vehicle after the change in the autonomous level. In certain embodiments, the historical autonomous level data can include an indication of an increase or a decrease in the autonomous level for the vehicles after the change in the autonomous level. In an example, the level of defined autonomy indicated by the autonomous level data can include Level 0 that corresponds to no automation for a vehicle traveling along the one or more road segments associated with the first geographic area, Level 1 that corresponds to a certain degree of driver assistance for a vehicle traveling along the one or more road segments associated with the first geographic area, Level 2 that corresponds to partial automation for a vehicle traveling along the one or more road segments associated with the first geographic area, Level 3 that corresponds to conditional automation for a vehicle traveling along the one or more road segments associated with the first geographic area, Level 4 that corresponds to high automation for a vehicle traveling along the one or more road segments associated with the first geographic area, Level 5 that corresponds to full automation for a vehicle traveling along the one or more road segments associated with the first geographic area, and/or another sub-level associated with a degree of autonomous driving for a vehicle traveling along the one or more road segments associated with the first geographic area. In an embodiment, the historical autonomous level data can include first autonomous level data indicative of a first level of defined autonomy of a vehicle before the change in the autonomous level for the vehicle. Additionally or alternatively, the historical autonomous level data can include second autonomous level data indicative of a second level of defined autonomy of a vehicle after the change in the autonomous level for the vehicle. For example, in an embodiment the historical autonomous level data can include an indication of an autonomous-level that a vehicle changed from (e.g., Level 3) and/or an indication of an autonomous-level that the vehicle changed to (e.g., Level 2).

Autonomous driving has become a focus of recent technology with recent advances in machine learning, computer vision, and computing power able to conduct real-time mapping and sensing of a vehicle's environment. Such an understanding of the environment enables autonomous driving in two distinct ways. Primarily, real-time or near real-time sensing of the environment can provide information about potential obstacles, the behavior of others on the roadway, and areas that are navigable by the vehicle. An understanding of the location of other vehicles and/or what the other vehicles have done and may be predicted to do may be useful for a vehicle (or apparatus 102) to safely plan a route.

Autonomous vehicles or vehicles with some level of autonomous controls provide some degree of vehicle control that was previously performed by a person driving a vehicle. Removing some or all of the responsibilities of driving from a person and automating those responsibilities require a high degree of confidence in performing those responsibilities in a manner at least as good as a human driver. For example, maintaining a vehicle's position within a lane by a human involves steering the vehicle between observed lane markings and determining a lane when lane markings are faint, absent, or not visible due to weather (e.g., heavy rain, snow, bright sunlight, etc.). As such, it is desirable for the autonomous vehicle to be equipped with sensors sufficient to observe road features, and a controller that is capable of processing the signals from the sensors observing the road features, interpret those signals, and provide vehicle control to maintain the lane position of the vehicle based on the sensor data. Maintaining lane position is merely one illustrative example of a function of autonomous or semi-autonomous vehicles that demonstrates the sensor level and complexity of autonomous driving. However, autonomous vehicle capabilities, particularly in fully autonomous vehicles, must be capable of performing all driving functions. As such, the vehicles must be equipped with sensor packages that enable the functionality in a safe manner.

In one or more embodiments, the apparatus 102, such as the processing circuitry 106, can be configured to additionally access the location data associated with the vehicles traveling along the one or more road segments associated with the first geographic area. In one or more embodiments, the location data associated with the vehicles traveling along the one or more road segments associated with the first geographic area can include geographic coordinates for the vehicles. In an embodiment, the location data associated with the vehicles traveling along the one or more road segments associated with the first geographic area can include latitude data and/or longitude data defining the location of the vehicles. In an aspect, the location data can be generated based on the one or more sensors 112. For example, in an embodiment, the apparatus 102, such as the processing circuitry 106, can receive the location data associated with the vehicles traveling along the one or more road segments associated with the first geographic area from a GPS or other location sensor of the vehicles. In another embodiment, the apparatus 102, such as the processing circuitry 106, can receive the location data associated with the vehicles traveling along the one or more road segments associated with the first geographic area from a LiDAR sensor of the vehicles. In yet another embodiment, the apparatus 102, such as the processing circuitry 106, can receive the location data associated with the vehicles traveling along the one or more road segments associated with the first geographic area from one or more ultrasonic sensors and/or one or more infrared sensors of the vehicles. Additionally, in one or more embodiments, the location data associated with the vehicles traveling along the one or more road segments associated with the first geographic area can include information associated with the change in the autonomous level for the vehicles. For instance, in an embodiment, the location data associated with the vehicles traveling along the one or more road segments associated with the first geographic area can include first location data associated with a decision by a processor (e.g., the processing circuitry 106 or other processing circuitry) of the vehicles to initiate the change in the autonomous level for the vehicles. Additionally or alternatively, the location data can include second location data associated with execution of the change in the autonomous level by a processor (e.g., the processing circuitry 106 or other processing circuitry) of the vehicles.

In certain embodiments, the apparatus 102, such as the processing circuitry 106, can be configured to additionally access time data associated with the vehicles traveling along the one or more road segments associated with the first geographic area. The time data can be associated with the change in the autonomous level for the vehicles traveling along the one or more road segments associated with the first geographic area. In one or more embodiments, the apparatus 102, such as the processing circuitry 106, can be configured to receive first time data associated with the decision to initiate the change in the autonomous level for the vehicles traveling along the one or more road segments associated with the first geographic area. Additionally or alternatively, in one or more embodiments, the apparatus 102, such as the processing circuitry 106, can be configured to receive second time data associated with the execution of the change in the autonomous level for the vehicles traveling along the one or more road segments associated with the first geographic area. In certain embodiments, the apparatus 102, such as the processing circuitry 106, can be configured to additionally receive vehicle version data associated with one or more components of the vehicles that facilitate autonomous driving of the vehicles traveling along the one or more road segments associated with the first geographic area. In certain embodiments, the apparatus 102, such as the processing circuitry 106, can be configured to additionally receive vehicle data associated with a vehicle type for the vehicles traveling along the one or more road segments associated with the first geographic area. In certain embodiments, the apparatus 102, such as the processing circuitry 106, can be configured to additionally receive vehicle context data associated with a reason for the transition in the autonomous level for the vehicles traveling along the one or more road segments associated with the first geographic area. In certain embodiments, the apparatus 102, such as the processing circuitry 106, can be configured to additionally receive sensor data (e.g., sensor data associated with the one or more sensors 112) that facilitate autonomous driving of the vehicles traveling along the one or more road segments associated with the first geographic area.

In an embodiment, the apparatus 102, such as the processing circuitry 106, can be configured to access one or more indications of a decrease in a strength of a communication signal associated with the vehicles while traveling along the one or more road segments. Additionally or alternatively, in an embodiment, the apparatus 102, such as the processing circuitry 106, can be configured to access one or more indications that the one or more road segments associated with the vehicles satisfy a defined criterion associated with a particular road condition. Additionally or alternatively, in an embodiment, the apparatus 102, such as the processing circuitry 106, can be configured to access accessing sensor data (e.g., sensor data from the one or more sensors 112) in response to a change in respective autonomous levels for the vehicles. Additionally or alternatively, in an embodiment, the apparatus 102, such as the processing circuitry 106, can be configured to access environmental data associated with a reason for a change in respective autonomous levels for the vehicles.

In one or more embodiments, the apparatus 102, such as the processing circuitry 106, can be configured to access the historical autonomous transition data, the autonomous transition data, the location data, the time data (e.g., the first time data and/or the second time data), the sensor data, the vehicle version data, the vehicle data, the vehicle context data, and/or other data associated with the vehicles traveling along the one or more road segments associated with the first geographic area. In one or more embodiments, the apparatus 102, such as the processing circuitry 106, can be configured to receive the historical autonomous transition data, the autonomous transition data, the location data, the time data (e.g., the first time data and/or the second time data), the sensor data, the vehicle version data, the vehicle data, the vehicle context data (e.g., from the vehicle), and/or the other data in response to the change in the autonomous level for the vehicles traveling along the one or more road segments associated with the first geographic area. In one or more embodiments, the apparatus 102, such as the processing circuitry 106, can be configured to receive the historical autonomous transition data, the autonomous transition data, the location data, the time data (e.g., the first time data and/or the second time data), the sensor data, the vehicle version data, the vehicle data, the vehicle context data, and/or the other data from a database.

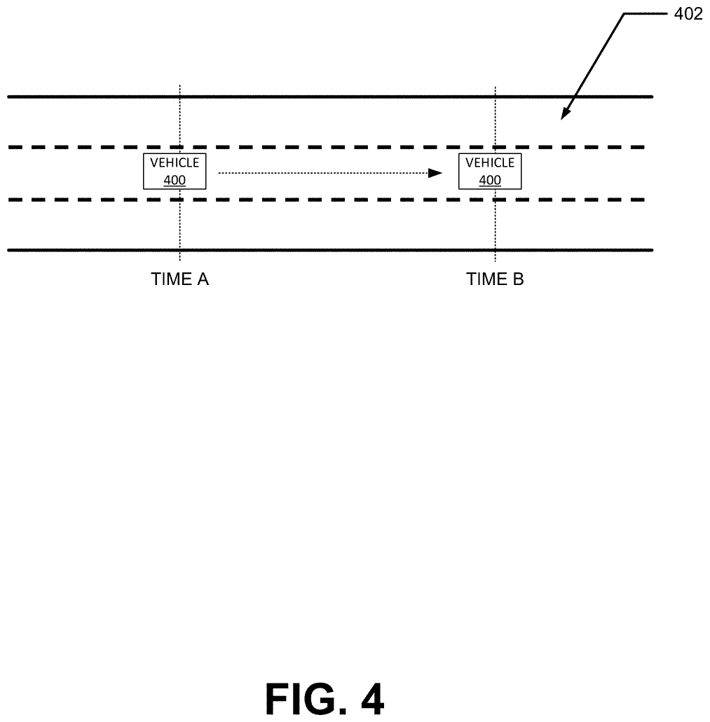

An example of a vehicle associated with the first geographic area is depicted in FIG. 4. As shown in FIG. 4, a vehicle 400 travels along a road segment 402. In one or more embodiments, the vehicle 400 can be an automobile where tires of the vehicle 400 are in contact with a road surface of the road segment 402. In an exemplary embodiment, the vehicle 400 can be associated with a first level of defined autonomy (e.g., Level 3) at a first time (e.g., TIME A shown in FIG. 4). Furthermore, at the first time (e.g., TIME A), the vehicle 400 can be associated with a first location (e.g., a particular latitude and/or longitude). In certain embodiments, the vehicle 400 (e.g., a processor of the vehicle 400) can initiate a change (e.g., a transition) in the autonomous level for the vehicle 400. For example, at the first time (e.g., TIME A shown in FIG. 4), the vehicle 400 can initiate the change in the autonomous level. Additionally, at a second time (e.g., TIME B shown in FIG. 4), the vehicle 400 can be associated with a second level of defined autonomy (e.g., Level 2). Furthermore, at the second time (e.g., TIME B), the vehicle 400 can be associated with a second location (e.g., a different latitude and/or longitude).

As shown in block 204 of FIG. 2, the apparatus 102 includes means, such as the processing circuitry 106, the memory 108, or the like, configured to identify one or more features of the historical autonomous transition data associated with the first geographic area. For instance, the one or more features can be one or more features of the historical autonomous transition data, the autonomous transition data, the location data, the time data (e.g., the first time data and/or the second time data), the vehicle version data, the vehicle data, the vehicle context data, and/or other data associated with the vehicles traveling along the one or more road segments associated with the first geographic area. In one or more embodiments, the one or more features can be associated with one or more points of interest associated with the historical autonomous transition data, one or more feature descriptors for the historical autonomous transition data, and/or one or more other ground truth features of the historical autonomous transition data.

In an embodiment, the apparatus 102 includes means, such as the processing circuitry 106, the memory 108, or the like, configured to identify a feature (e.g., a feature for the one or more features) associated with a distance between a cellular base station (e.g., a cellular network tower) and a road segment from the one or more road segments associated with the first geographic area. For example, in an embodiment, the apparatus 102 includes means, such as the processing circuitry 106, the memory 108, or the like, configured to determine the distance between the cellular base station and the road segment based on a Euclidian distance measurement. In certain embodiments, the apparatus 102 includes means, such as the processing circuitry 106, the memory 108, or the like, configured to determine the distance between a closest cellular base station and a centroid of an autonomous transition region. In another embodiment, the apparatus 102 includes means, such as the processing circuitry 106, the memory 108, or the like, configured to identify a feature (e.g., a feature for the one or more features) associated with a measure of a strength of a communication signal associated with the vehicles while traveling along a road segment of the one or more road segments associated with the first geographic area. For example, in an embodiment, the apparatus 102 includes means, such as the processing circuitry 106, the memory 108, or the like, configured to determine signal strength of a cellular signal associated with an autonomous transition region. In certain embodiments, the apparatus 102 includes means, such as the processing circuitry 106, the memory 108, or the like, configured to determine a measure of a reception signal at a particular autonomous vehicle level within an autonomous transition region.

In yet another embodiment, the apparatus 102 includes means, such as the processing circuitry 106, the memory 108, or the like, configured to identify a feature (e.g., a feature for the one or more features) associated with presence of a point of interest along a road segment of the one or more road segments associated with the first geographic area. For example, a point of interest can include a bus stop, a train stop, a pedestrian crosswalk, certain pedestrian density, a park, a school, another point of interest. In one or more embodiments, a point of interest can be a Boolean feature obtained from one or more map layers of a map associated with the map database 104 and/or another map database. In yet another embodiment, the apparatus 102 includes means, such as the processing circuitry 106, the memory 108, or the like, configured to identify a feature (e.g., a feature for the one or more features) associated with a road condition for a road segment of the one or more road segments associated with the first geographic area. In one embodiment, the road condition can be a Boolean feature obtained from one or more map layers of a map associated with the map database 104 and/or another map database. In another embodiment, the road condition can be a real-time road condition associated with the one or more road segments in the first geographic area. In yet another embodiment, the apparatus 102 includes means, such as the processing circuitry 106, the memory 108, or the like, configured to identify a feature (e.g., a feature for the one or more features) associated with a pedestrian traffic condition for a road segment of the one or more road segments associated with the first geographic area. However, it is to be appreciated that, in one or more embodiments, the apparatus 102 includes means, such as the processing circuitry 106, the memory 108, or the like, configured to additionally or alternatively identify a feature (e.g., a feature for the one or more features) related to other data associated with the historical autonomous transition data, the autonomous transition data, the location data, the time data (e.g., the first time data and/or the second time data), the vehicle version data, the vehicle data, the vehicle context data, and/or other data associated with the vehicles traveling along the one or more road segments associated with the first geographic area.

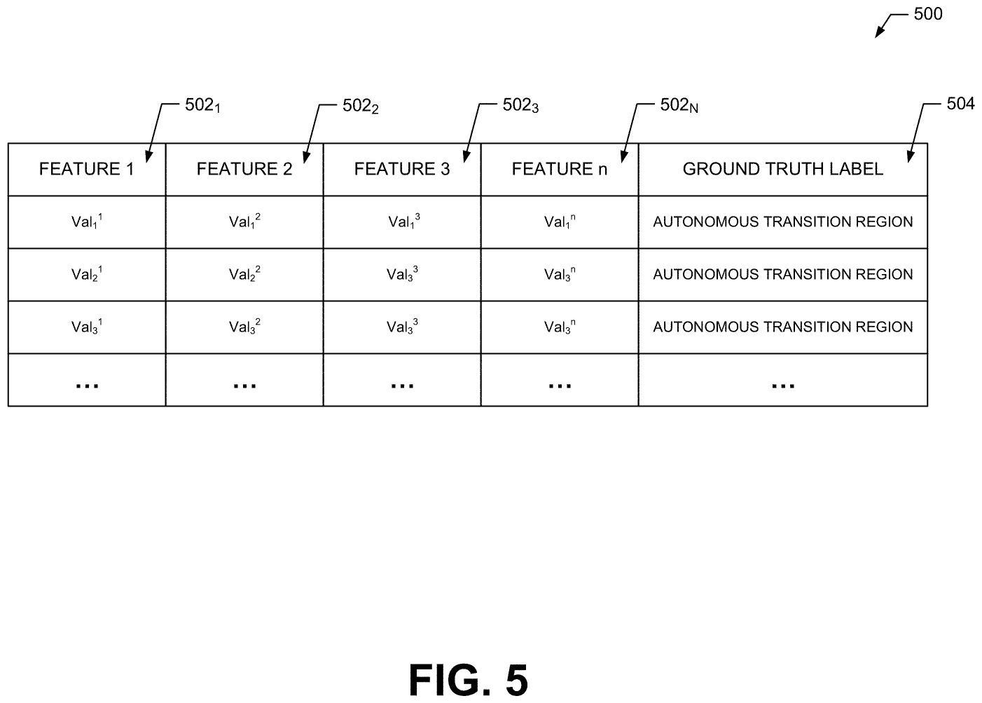

In an embodiment, the apparatus 102 includes means, such as the processing circuitry 106, the memory 108, or the like, configured to identify at least a portion the one or more features based on positive feature examples associated with the historical autonomous transition data for the first geographic area. FIG. 5 illustrates exemplary training data 500 for the autonomous transition prediction. For instance, the training data 500 can include features 502_{1-N} and a respective ground truth label 504 for an autonomous transition region where Valᵢ^{j} indicates an i^{th} tuple in the training data 500 for feature j. In an aspect, the features 502_{1-N} can be one or more features for training a machine learning model and/or predicting autonomous transition data. For example, in an embodiment, the feature 502₁ can be one or more features related to 5G (e.g., distance of a closest 5G cell tower to a particular location of an autonomous transition region, 5G signal strength associated with an autonomous transition region, etc.). Additionally or alternatively, in an example, the feature 502₂ can be related to high pedestrian traffic (e.g., presence of a bus stop in an autonomous transition region, presence of a pedestrian cross walk in an autonomous transition region, presence of train stop in an autonomous transition region, presence of a particular degree of pedestrian traffic density in an autonomous transition region, presence of a point of interest in an autonomous transition region, etc.). Additionally or alternatively, in an example, the feature 502₃ can be related to road construction in an autonomous transition region and/or one or more lane changes in an autonomous region that are not reflected in a map database (e.g., map database 104, etc.). In certain embodiments, the apparatus 102, such as the processing circuitry 106, can be configured to additionally identify at least a portion the one or more features based on negative feature examples associated with the historical autonomous transition data for the first geographic area. For example, in certain embodiments, the apparatus 102, such as the processing circuitry 106, can be configured to additionally determine features for other regions (e.g., non-transition regions) that are not an autonomous transition region (or transition region) in the first geographic area to facilitate distinguishing between prediction of autonomous transition regions and non-transition regions.

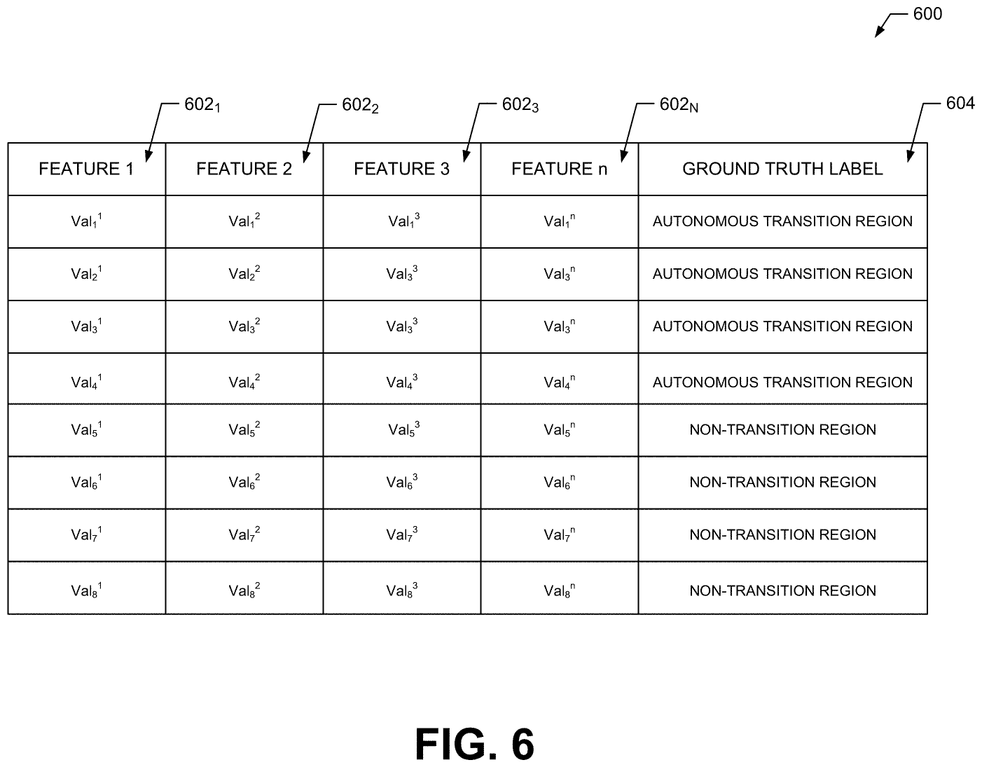

FIG. 6 illustrates exemplary training data 600 for the autonomous transition prediction where negative ground truth features are included in the training data 600. In an exemplary embodiment, a number of negative ground truth features in the training data 600 can be equal to or greater than a number of positive ground truth features in the training data 600. In another exemplary embodiment, a number of negative ground truth features in the training data 600 can be less than a number of positive ground truth features in the training data 600. In an aspect, the training data 600 can include features 602_{1-N} and a respective ground truth label 604 for an autonomous transition region where Valᵢ^{j} indicates an i^{th} tuple in the training data 600 for feature j. In an aspect, the features 602_{1-N} can be one or more features for training a machine learning model and/or predicting autonomous transition data. For example, in an embodiment, the feature 602₁ can be one or more features related to 5G (e.g., distance of a closest 5G cell tower to a particular location of an autonomous transition region, 5G signal strength associated with an autonomous transition region, etc.). Additionally or alternatively, in an example, the feature 602₂ can be related to high pedestrian traffic (e.g., presence of a bus stop in an autonomous transition region, presence of a pedestrian cross walk in an autonomous transition region, presence of train stop in an autonomous transition region, presence of a particular degree of pedestrian traffic density in an autonomous transition region, presence of a point of interest in an autonomous transition region, etc.). Additionally or alternatively, in an example, the feature 602₃ can be related to road construction in an autonomous transition region and/or one or more lane changes in an autonomous region that are not reflected in a map database (e.g., map database 104, etc.).

As shown in block 206 of FIG. 2, the apparatus 102 includes means, such as the processing circuitry 106, the memory 108, or the like, configured to train a machine learning model based on the one or more features associated with the first geographic area. For example, in one or more embodiments, the apparatus 102, such as the processing circuitry 106, can be configured to train the machine learning model based on the historical autonomous transition data and/or the one or more features for the historical autonomous transition data. The machine learning model can be a machine learning model for autonomous transition prediction. For instance, in one or more embodiments, the machine learning model can include model data and/or a prediction algorithm associated with autonomous transition prediction. In an embodiment, the machine learning model can be a decision tree model associated with a tree-like decision structure to facilitate autonomous transition prediction. In another embodiment, the machine learning model can be a random forest model associated with one or more random decision forest structures to facilitate autonomous transition prediction. In yet another embodiment, the machine learning model can be a neural network model (e.g., a deep learning model, an artificial neural network model, a convolutional neural network model, etc.) associated with artificial neural structures, convolutional layers, pooling layers, fully connected layers, connections, and/or weights to facilitate autonomous transition prediction. In various embodiments, the apparatus 102, such as the processing circuitry 106, can be configured to repeatedly train the machine learning model until a certain degree of accuracy is achieved for the machine learning model. For example, in various embodiments, the apparatus 102, such as the processing circuitry 106, can be configured to repeatedly train the machine learning model until accuracy of the machine learning model is equal to or greater than a specific accuracy threshold value (e.g., a defined F-score value). In various embodiments, the apparatus 102, such as the processing circuitry 106, can be configured to rank features for the machine learning model (e.g., based on an information gain technique or a chi-square technique) to facilitate filtering data (e.g., one or more features) from the training dataset.

In various embodiments, the apparatus 102, such as the processing circuitry 106, can be configured to train the machine learning model based on one or more features associated with the historical autonomous transition data, the autonomous transition data, the location data, the time data (e.g., the first time data and/or the second time data), the vehicle version data, the vehicle data, the vehicle context data, and/or other data associated with the vehicles traveling along the one or more road segments associated with the first geographic area. For instance, in one or more embodiments, the apparatus 102, such as the processing circuitry 106, can be configured to train the machine learning model based on one or more features associated with a distance between a cellular base station (e.g., a cellular network tower) and a road segment from the one or more road segments associated with the first geographic area. Additionally or alternatively, in one or more embodiments, the apparatus 102, such as the processing circuitry 106, can be configured to train the machine learning model based on one or more features associated with a measure of a strength of a communication signal associated with the vehicles while traveling along a road segment of the one or more road segments associated with the first geographic area. Additionally or alternatively, in one or more embodiments, the apparatus 102, such as the processing circuitry 106, can be configured to train the machine learning model based on one or more features associated with presence of a point of interest along a road segment of the one or more road segments associated with the first geographic area. Additionally or alternatively, in one or more embodiments, the apparatus 102, such as the processing circuitry 106, can be configured to train the machine learning model based on one or more features associated with a road condition for a road segment of the one or more road segments associated with the first geographic area. Additionally or alternatively, in one or more embodiments, the apparatus 102, such as the processing circuitry 106, can be configured to train the machine learning model based on one or more features associated with a pedestrian traffic condition for a road segment of the one or more road segments associated with the first geographic area. In various embodiments, the apparatus 102, such as the processing circuitry 106, can be configured to employ one or more other features not included the historical autonomous transition data. For example, in various embodiments, the apparatus 102, such as the processing circuitry 106, can be configured to employ one or more other features associated with one or more other geographic areas to facilitate training of the machine learning mode.

As shown in block 208 of FIG. 2, in one or more embodiments, the apparatus 102 additionally includes means, such as the processing circuitry 106, the memory 108, or the like, configured to predict autonomous transition data for a second geographic area based on the machine learning model associated with the first geographic area. For example, in one or more embodiments, the apparatus 102, such as the processing circuitry 106, can be configured to predict autonomous transition data, location data, time data, vehicle version data, vehicle data, vehicle context data, and/or other data associated with vehicles that will travel along one or more road segments associated with the second geographic area during a future interval of time. In one or more embodiments, the apparatus 102, such as the processing circuitry 106, can be configured to predict one or more autonomous transition regions (such as a transition region or a non-transition region) for the second geographic area based on the machine learning model associated with the first geographic area. The second geographic area can be, for example, at least a portion of a geographic region, at least a portion of a city, at least a portion of a town, at least a portion of a neighborhood, at least a portion of a state, at least a portion of a country, etc. Furthermore, the second geographic area can be a different geographic area than the first geographic area.

In one or more embodiments, the second geographic area can include one or more spatial reference points. A spatial reference point can be a portion of a road segment and/or portion of the second geographic area. For example, in an embodiment, a spatial reference point can be a location point on a road segment associated with the second geographic area. In another embodiment, a reference point can be a geometric shape that represents at least a portion of a road segment associated with the second geographic area. In yet another embodiment, a spatial reference point can be a geometric shape that represents an area that includes one or more road segments associated with the second geographic area. In a non-limiting example, a spatial reference point can be a tile (e.g., a grid cell, a square area, a rectangular area, etc.) associated with one or more portions of one or more road segments associated with the second geographic area. For example, a spatial reference point can be a tile (e.g., a grid cell, a square area, a rectangular area, etc.) associated with a 500 meter by 500 meter geographic area associated with the second geographic area. In another non-limiting example, a spatial reference point can be a polygon associated with one or more portions of one or more road segments and/or a geographic area. In yet another non-limiting example, a spatial reference point can be a line associated with one or more portions of one or more road segments associated with the second geographic area. However, it is to be appreciated that, in one or more embodiments, a spatial reference point can be another geometric shape associated with one or more portions of one or more road segments associated with the second geographic area.

In one or more embodiments, one or more features associated with the historical autonomous transition data for the first geographic area can be determined for the second geographic area. The one or more features associated with the second geographic area can be, for example, one or more features of autonomous transition data for the second geographic area. For instance, the one or more features associated with the second geographic area can be one or more features associated with autonomous transition data, location data, time data, vehicle version data, vehicle data, vehicle context data, and/or other data associated with the second geographic area. In one or more embodiments, the one or more features associated with the second geographic area can be associated with one or more points of interest associated with the historical autonomous transition data, one or more feature descriptors for the historical autonomous transition data, and/or one or more other ground truth features of the historical autonomous transition data. In one or more embodiments, the apparatus 102, such as the processing circuitry 106, can be configured to employ the machine learning model trained based on data from the first geographic area to determine whether one or more regions (e.g., one or more spatial reference points) of the second geographic area is an autonomous transition region or a non-transition region. In one or more embodiments, the apparatus 102, such as the processing circuitry 106, can be configured to additionally determine a probability for the predicted autonomous transition data for the second geographic area. For example, in an embodiment, the apparatus 102, such as the processing circuitry 106, can be configured to mark a region (e.g. a spatial reference point) of the second geographic area as an autonomous transition region in response to a determination that the probability for the region satisfies a defined probability level (e.g., is equal to or above a 70% probability). In another embodiment, the apparatus 102, such as the processing circuitry 106, can be configured to mark a region (e.g. a spatial reference point) of the second geographic area as a non-transition region in response to a determination that the probability for the region does not satisfy a defined probability level (e.g., is less than a 70% probability). In certain embodiments, the apparatus 102, such as the processing circuitry 106, can be configured to mark a region (e.g. a spatial reference point) of the second geographic area for further processing (e.g., by a user) in response to a determination that the probability for the region does not satisfy a first defined probability level (e.g., is below a 70% probability) but satisfies a second defined probability level (e.g., is equal to or above a 55% probability). In certain embodiments, the apparatus 102, such as the processing circuitry 106, can be configured to predict the autonomous transition data for the second geographic area during two or more intervals of time.

In certain embodiments, the apparatus 102, such as the processing circuitry 106, can be configured to cause, via an electronic interface, rendering of data generated by the machine learning model. For example, in certain embodiments, the apparatus 102, such as the processing circuitry 106, can be configured to cause, via an electronic interface, rendering of one or more graphical elements and/or a visual representation associated with the predicted autonomous transition data for the second geographic area. In certain embodiments, the apparatus 102, such as the processing circuitry 106, can be configured to facilitate routing of a vehicle based on the machine learning model. For example, in certain embodiments, the apparatus 102, such as the processing circuitry 106, can be configured to facilitate routing of a vehicle (e.g., a vehicle in the second geographic area) based on the predicted autonomous transition data for the second geographic area. In certain embodiments, the apparatus 102, such as the processing circuitry 106, can be configured to cause rendering of a navigation route via a map display based on the machine learning model. For example, in certain embodiments, the apparatus 102, such as the processing circuitry 106, can be configured to cause rendering of a navigation route via a map display (e.g. a map display of a vehicle in the second geographic area) based on the predicted autonomous transition data for the second geographic area. In certain embodiments, the apparatus 102, such as the processing circuitry 106, can be configured to rank the second geographic area against one or more other geographic areas based on the predicted autonomous transition data for the second geographic area (e.g., to determine geographic areas with potential autonomous driving issues).

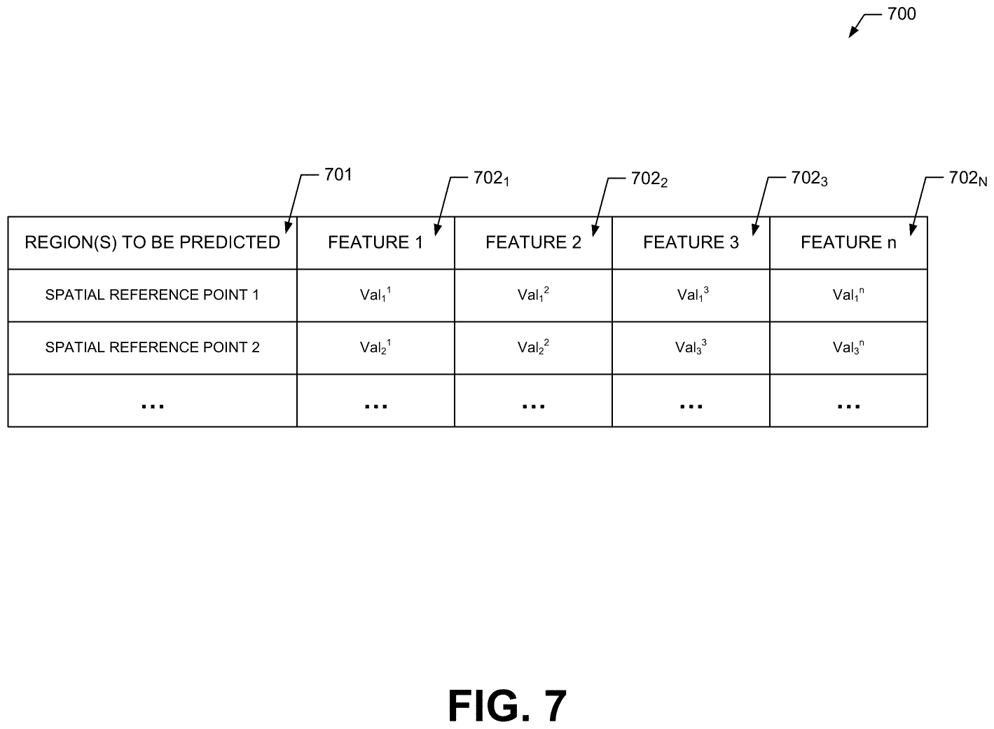

FIG. 7 illustrates exemplary feature data 700 for one or more regions to be predicted in the second geographic area. For example, the second geographic area can include one or more regions to be predicted 701 (e.g., spatial reference point 1 in the second geographic area, spatial reference point 2 in the second geographic area, etc.). In an aspect, the feature data 700 can include features 702_{1-N} for the one or more regions to be predicted 701 where Valᵢ^{j} indicates an i^{th} tuple in the feature data 700 for feature j. As such, one or more features associated with the second geographic area can be employed as input to the machine learning model to facilitate prediction of autonomous transition data for the one or more regions to be predicted 701 (e.g., spatial reference point 1 in the second geographic area, spatial reference point 2 in the second geographic area, etc.) for the second geographic area.

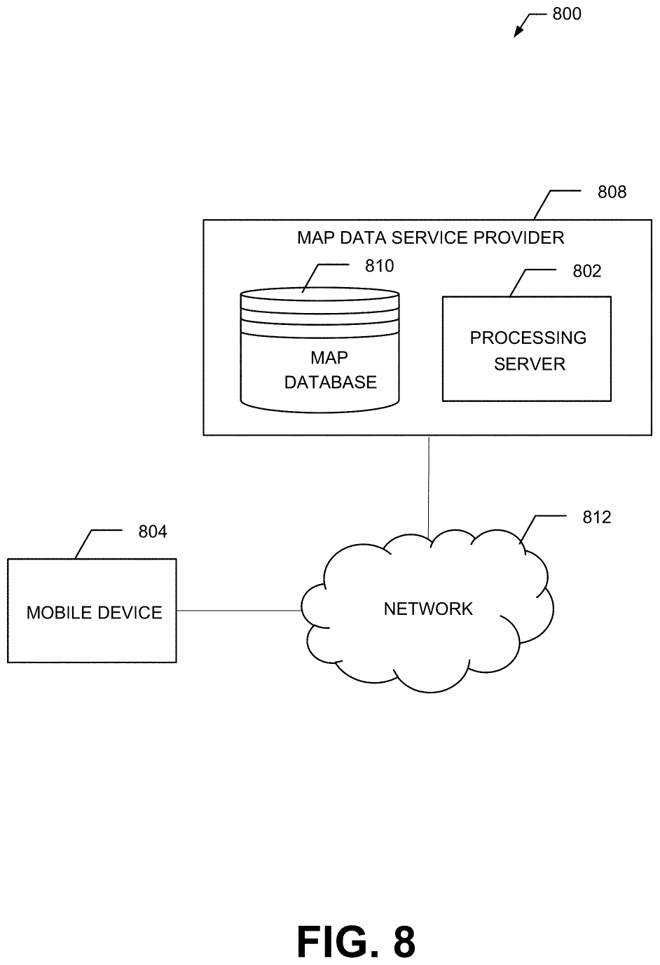

In certain embodiments, to facilitate navigation of the vehicle and/or providing the indication of the queue of vehicles to the vehicle, the apparatus 102 can support a mapping, navigation, and/or autonomous driving application so as to present maps or otherwise provide navigation or driver assistance, such as in an example embodiment in which map data is created or updated using methods described herein. For example, the apparatus 102 can provide for display of a map and/or instructions for following a route within a network of roads via a user interface (e.g., a graphical user interface). In order to support a mapping application, the apparatus 102 can include or otherwise be in communication with a geographic database, such as map database 104, a geographic database stored in the memory 108, and/or map database 810 shown in FIG. 8. For example, the geographic database can include node data records, road segment or link data records, point of interest (POI) data records, and other data records. More, fewer or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology can be used, such as electronic horizon sensors, radar, LiDAR, ultrasonic sensors and/or infrared sensors. In one or more embodiments, the other autonomous level data can be stored in the map database 104, the map database 810, and/or another database accessible by the apparatus 102.

In example embodiments, a navigation system user interface and/or an autonomous driving user interface can be provided to provide driver assistance to a user traveling along a network of roadways where data collected from the vehicle (e.g., the vehicle 400) associated with the navigation system user interface can aid in establishing a position of the vehicle along a road segment (e.g., a road segment associated with the second geographic area) and/or can provide assistance for autonomous or semi-autonomous vehicle control of the vehicle. Autonomous vehicle control can include driverless vehicle capability where all vehicle functions are provided by software and hardware to safely drive the vehicle along a path identified by the vehicle. Semi-autonomous vehicle control can be any level of driver assistance from adaptive cruise control, to lane-keep assist, or the like. Establishing vehicle location and position along a road segment can provide information useful to navigation and autonomous or semi-autonomous vehicle control by establishing an accurate and highly specific position of the vehicle on a road segment and even within a lane of the road segment such that map features in the map, e.g., a high definition (HD) map, associated with the specific position of the vehicle can be reliably used to aid in guidance and vehicle control.

A map service provider database can be used to provide driver assistance, such as via a navigation system and/or through an Advanced Driver Assistance System (ADAS) having autonomous or semi-autonomous vehicle control features. Referring back to FIG. 8, illustrated is a communication diagram of an example embodiment of a system for implementing example embodiments described herein. The illustrated embodiment of FIG. 8 includes a mobile device 804, which can be, for example, the apparatus 102 of FIG. 1, such as a mobile phone, an in-vehicle navigation system, an ADAS, or the like. The illustrated embodiment of FIG. 8 also includes a map data service provider 808. The mobile device 804 and the map data service provider 808 can be in communication via a network 812. The network 812 can be any form of wireless or partially wireless network as will be described further below. Additional, different, or fewer components can be provided. For example, many mobile devices 804 can connect with the network 812. In an embodiment, the map data service provider can be a cloud service. For instance, in certain embodiments, the map data service provider 808 can provide cloud-based services and/or can operate via a hosting server that receives, processes, and provides data to other elements of the system 800.

The map data service provider 808 can include a map database 810 that can include node data, road segment data or link data, point of interest (POI) data, traffic data or the like. In one embodiment, the map database 810 can be different than the map database 104. In another embodiment, at least a portion of the map database 810 can correspond to the map database 104. The map database 810 can also include cartographic data, routing data, and/or maneuvering data. According to some example embodiments, the road segment data records can be links or segments representing roads, streets, or paths, as can be used in calculating a route or recorded route information for determination of one or more personalized routes. The node data can be end points corresponding to the respective links or segments of road segment data. The road link data and the node data can represent a road network, such as used by vehicles, cars, trucks, buses, motorcycles, and/or other entities. Optionally, the map database 810 can contain path segment and node data records or other data that can represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 810 can include data about the POIs and their respective locations in the POI records. The map database 810 can include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 810 can include event data (e.g., traffic incidents, construction activities, scheduled events, unscheduled events, etc.) associated with the POI data records or other records of the map database 810.

The map database 810 can be maintained by the map data service provider 808 and can be accessed, for example, by a processing server 802 of the map data service provider 808. By way of example, the map data service provider 808 can collect geographic data and/or dynamic data to generate and enhance the map database 810. In one example, the dynamic data can include traffic-related data. There can be different ways used by the map data service provider 808 to collect data. These ways can include obtaining data from other sources, such as municipalities or respective geographic authorities, such as via global information system databases. In addition, the map data service provider 808 can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that can be available is vehicle data provided by vehicles, such as provided, e.g., as probe points, by mobile device 804, as they travel the roads throughout a region.

In certain embodiments, at least a portion of the map database 104 can be included in the map database 810. In an embodiment, the map database 810 can be a master map database, such as an HD map database, stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems. For example, geographic data can be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device 804, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database 810 of the map data service provider 808 can be a master geographic database, but in alternate embodiments, a client side map database can represent a compiled navigation database that can be used in or with end user devices (e.g., mobile device 804) to provide navigation and/or map-related functions. For example, the map database 810 can be used with the mobile device 804 to provide an end user with navigation features. In such a case, the map database 810 can be downloaded or stored on the end user device which can access the map database 810 through a wireless or wired connection, such as via a processing server 802 and/or the network 812, for example.

In one embodiment, as noted above, the end user device or mobile device 804 can be embodied by the apparatus 102 of FIG. 1 and can include an ADAS which can include an infotainment in-vehicle system or an in-vehicle navigation system, and/or devices such as a personal navigation device (PND), a portable navigation device, a cellular telephone, a smart phone, a personal digital assistant (PDA), a watch, a camera, a computer, a server and/or other device that can perform navigation-related functions, such as digital routing and map display. An end user can use the mobile device 804 for navigation and map functions such as guidance and map display, for example, and for determination of useful driver assistance information, according to some example embodiments.

In one or more embodiments, the apparatus 102, such as the processing circuitry 106, can be additionally or alternatively configured to facilitate routing of a vehicle associated with the second geographic region based on the predicted autonomous transition data for the second geographic area. In one or more embodiments, the apparatus 102, such as the processing circuitry 106, can be additionally or alternatively configured to cause rendering of data via a map display of a vehicle associated with the second geographic region based on the predicted autonomous transition data for the second geographic area. For example, in one or more embodiments, the apparatus 102, such as the processing circuitry 106, can be additionally or alternatively configured to render a certain type of visual indicator (e.g., a red color, a green color, a yellow color, etc.) via a map display of a vehicle associated with the second geographic region based on the predicted autonomous transition data for the second geographic area.

In certain embodiments, the apparatus 102, such as the processing circuitry 106, can be configured to map the indication of the queue of vehicles onto one or more map data layers of a map (e.g., an HD map) to facilitate the autonomous driving for the vehicle and/or one or more other vehicles. For instance, in certain embodiments, the apparatus 102, such as the processing circuitry 106, can be configured to store the predicted autonomous transition data for the second geographic area in a map data layer of a map (e.g., an HD map) for mapping purposes, navigation purposes, and/or autonomous driving purposes associated with the road segment. In certain embodiments, the apparatus 102, such as the processing circuitry 106, can be configured to link and/or associate the predicted autonomous transition data for the second geographic area with one or more portions, components, areas, layers, features, text, symbols, and/or data records of a map (e.g., an HD map) associated with the road segment. In one or more embodiments, the apparatus 102, such as the processing circuitry 106, can be configured to generate a data point for a map layer associated with the road segment based on the predicted autonomous transition data for the second geographic area. The data point can indicate autonomous transition data for and/or a location associated with the second geographic region. Additionally or alternatively, in one or more embodiments, the apparatus 102, such as the processing circuitry 106, can be configured to store the data point in the database associated with a map layer associated with the second geographic region.

In one or more embodiments, the apparatus 102, such as the processing circuitry 106, can be configured to generate one or more road links (e.g., one or more map-matched road links) for the predicted autonomous transition data for the second geographic area to facilitate an autonomous level prediction for one or more vehicles associated with the second geographic area. For instance, in one or more embodiments, the apparatus 102, such as the processing circuitry 106, can be configured to map the predicted autonomous transition data for the second geographic area onto a road network map associated with the second geographic region. In one or more embodiments, the apparatus 102, such as the processing circuitry 106, can be configured to generate and/or update transition pattern data (e.g., disengagement pattern data and/or engagement pattern data) for a map layer associated with the second geographic area based on the predicted autonomous transition data for the second geographic area. For example, in one or more embodiments, the apparatus 102, such as the processing circuitry 106, can be configured to generate and/or update transition patterns (e.g., disengagement patterns and/or engagement patterns) associated with historical data for the second geographic area. In one or more embodiments, the apparatus 102, such as the processing circuitry 106, can be configured to combine real-time transition data for the second geographic area with historical transition patterns (e.g., historical disengagement patterns and/or historical engagement patterns) for the second geographic area. In one or more embodiments, the predicted autonomous transition data for the second geographic area can be encoded in the database and/or can be employed by one or more vehicles associated with the second geographic area to facilitate autonomous driving for one or more vehicles when traveling within the second geographic area. In one or more embodiments, one or more notifications can be provided to a display of one or more vehicles associated with the second geographic area based on the predicted autonomous transition data for the second geographic area.

In certain embodiments, the apparatus 102, such as the processing circuitry 106, can be configured to employ a trained version of the machine learning model to predict one or more autonomous transition regions for a geographic area. For example, in certain embodiments, the apparatus 102, such as the processing circuitry 106, can be configured to determine one or more features associated with one or more first vehicles traveling along a road segment associated with a first geographic area. Additionally, in certain embodiments, the apparatus 102, such as the processing circuitry 106, can be configured to predict, using a machine learning model that receives the one or more features, whether the road segment comprises an autonomous transition area in which a particular number of vehicles are transitioned from respective autonomous levels. For example, in one or more embodiments, the machine learning model can be trained based on historical autonomous transition data associated with one or more second vehicles that are transitioned from respective autonomous levels while traveling along one or more road segments within a second geographic area, different than the first geographic area.

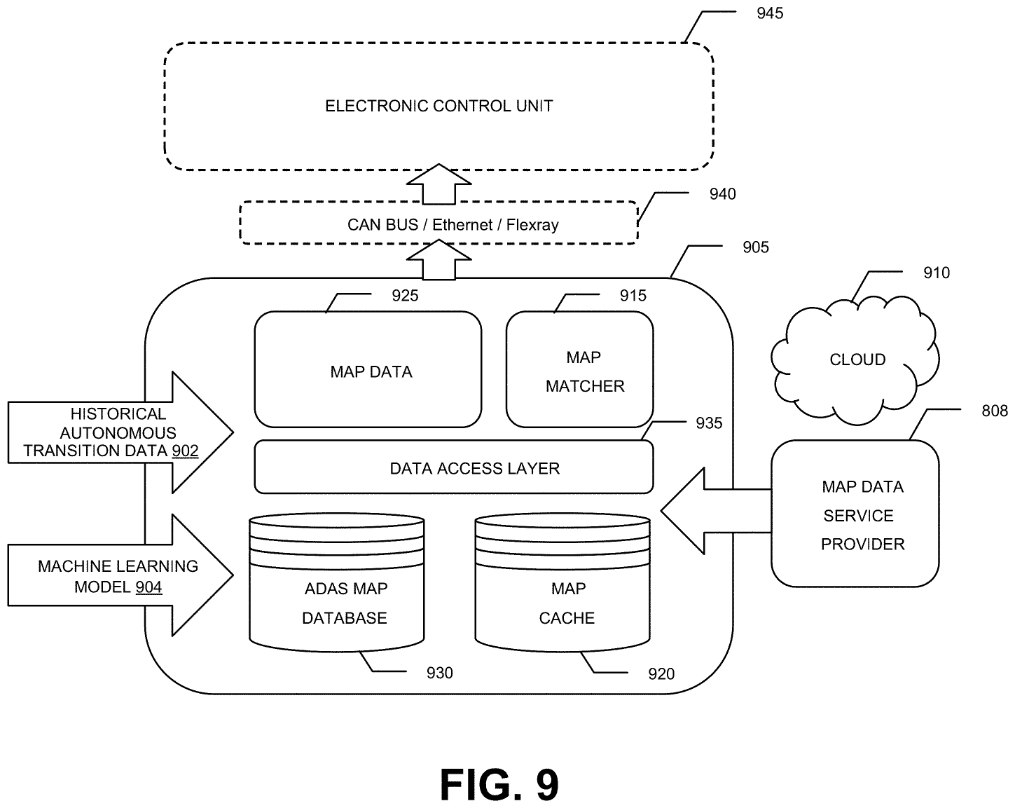

FIG. 9 illustrates an example embodiment of an architecture specifically configured for implementing embodiments described herein. The illustrated embodiment of FIG. 9 may be vehicle-based, where historical autonomous transition data 902 is determined for one or more vehicles (e.g., the vehicle 400) traveling along one or more road segments associated with the first geographic area. Additionally or alternatively, in one or more embodiments autonomous level data, location data and/or other data can be obtained from vehicles to facilitate training and/or generation of a machine learning model 904. In one or more embodiments, location data associated with one or vehicles can be obtained from the one or more vehicles using GPS or other localization techniques to facilitate predicting autonomous transition data for a second geographic area based on the machine learning model 904. According to one or more embodiments, the historical autonomous transition data 902 can be correlated to map data of the map data service provider 808. A vehicle with autonomous or semi-autonomous control may establish accurate location and/or improved autonomous driving functionality through the historical autonomous transition data 902, the machine learning model 904 and/or predicted autonomous transition data generated based on the machine learning model 904 to facilitate the autonomous or semi-autonomous control.

As illustrated in FIG. 9, the architecture includes the map data service provider 808 that provides map data 925 (e.g., HD maps and policies associated with road links within the map) to an Advanced Driver Assistance System (ADAS) 905, which may be vehicle-based or server based depending upon the application. The map data service provider 808 may be a cloud-based 910 service. In one or more embodiments, the ADAS 905 receives the autonomous transition data 902 and may provide autonomous transition data 902 to map matcher 915. The map matcher 915 may correlate the autonomous transition data 902 to a road link on a map of the mapped network of roads stored in the map cache 920. This link or segment, along with the direction of travel, may be used to establish which HD map policies are applicable to the vehicle associated with the ADAS 905, including sensor capability information, autonomous functionality information, etc. Accordingly, in one or more embodiments, policies for one or more vehicles are established based on the autonomous transition data 902. The map data 925 associated with the road segment specific to the vehicle are provided to the vehicle control, such as via the CAN (computer area network) BUS (or Ethernet or Flexray) 940 to the electronic control unit (ECU) 945 of the vehicle to implement HD map policies, such as various forms of autonomous or assisted driving, or navigation assistance. In certain embodiments, a data access layer 935 can manage and/or facilitate access to the map cache 920, the map data 925, and/or an ADAS map database 930. In an embodiment, at least a portion of the ADAS map database 930 can correspond to the map database 104 and/or the map database 810.

By employing predicted autonomous transition data in accordance with one or more example embodiments of the present disclosure, precision and/or confidence of vehicle localization and/or autonomous driving for a vehicle can be improved. Furthermore, by employing predicted autonomous transition data in accordance with one or more example embodiments of the present disclosure, improved navigation of a vehicle can be provided, improved route guidance for a vehicle can be provided, improved semi-autonomous vehicle control can be provided, improved fully autonomous vehicle control can be provided, and/or improved safety of a vehicle can be provided. Moreover, in accordance with one or more example embodiments of the present disclosure, efficiency of an apparatus including the processing circuitry can be improved and/or the number of computing resources employed by processing circuitry can be reduced. In one or more embodiments, by employing predicted autonomous transition data in accordance with one or more example embodiments of the present disclosure, improved statistical information for a road segment can be provided to provide improved recommendations for infrastructure improvements and/or improved recommendations for autonomous transition regions for a geographic area.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Furthermore, in some embodiments, additional optional operations can be included. Modifications, additions, or amplifications to the operations above can be performed in any order and in any combination.

Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

That which is claimed:

1. A computer-implemented method for predicting autonomous transition regions using historical information, the computer-implemented method comprising:
accessing historical autonomous transition data associated with vehicles that transition from respective autonomous levels while traveling along one or more road segments associated with a first geographic area;
identifying one or more features of the historical autonomous transition data associated with the first geographic area; and
training a machine learning model based on the one or more features associated with the first geographic area.

2. The computer-implemented method of claim 1, further comprising:
predicting autonomous transition data for a second geographic area based on the machine learning model associated with the first geographic area.

3. The computer-implemented method of claim 1, wherein the accessing the historical autonomous transition data comprises accessing vehicle context data associated with a reason for a change in respective autonomous levels for the vehicles.

4. The computer-implemented method of claim 1, wherein the accessing the historical autonomous transition data comprises accessing one or more indications of a decrease in a strength of a communication signal associated with the vehicles while traveling along the one or more road segments.

5. The computer-implemented method of claim 1, wherein the accessing the historical autonomous transition data comprises accessing one or more indications that the one or more road segments associated with the vehicles satisfy a defined criterion associated with a particular road condition.

6. The computer-implemented method of claim 1, wherein the accessing the historical autonomous transition data comprises accessing sensor data in response to a change in respective autonomous levels for the vehicles.

7. The computer-implemented method of claim 1, wherein the identifying the one or more features comprises identifying a feature associated with a distance between a cellular base station and a road segment from the one or more road segments associated with the first geographic area, and
wherein the training the machine learning model comprises training the machine learning model based on the feature.

8. The computer-implemented method of claim 1, wherein the identifying the one or more features comprises identifying a feature associated with a measure of a strength of a communication signal associated with the vehicles while traveling along a road segment of the one or more road segments associated with the first geographic area, and
wherein the training the machine learning model comprises training the machine learning model based on the feature.

9. The computer-implemented method of claim 1, wherein the identifying the one or more features comprises identifying a feature associated with presence of a point of interest along a road segment of the one or more road segments associated with the first geographic area, and
wherein the training the machine learning model comprises training the machine learning model based on the feature.

10. The computer-implemented method of claim 1, wherein the identifying the one or more features comprises identifying a feature associated with a road condition for a road segment of the one or more road segments associated with the first geographic area, and
wherein the training the machine learning model comprises training the machine learning model based on the feature.

11. The computer-implemented method of claim 1, wherein the identifying the one or more features comprises identifying a feature associated with a pedestrian traffic condition for a road segment of the one or more road segments associated with the first geographic area, and
wherein the training the machine learning model comprises training the machine learning model based on the feature.

12. The computer-implemented method of claim 1, further comprising:
causing, via an electronic interface, rendering of data generated by the machine learning model.

13. The computer-implemented method of claim 1, further comprising:
facilitating routing of a vehicle based on the machine learning model.

14. The computer-implemented method of claim 1, further comprising:
causing rendering of a navigation route via a map display based on the machine learning model.

15. An apparatus configured to predict autonomous transition regions using historical information, the apparatus comprising processing circuitry and at least one memory including computer program code instructions, the computer program code instructions configured to, when executed by the processing circuitry, cause the apparatus to:
access historical autonomous transition data associated with vehicles that transition from respective autonomous levels while traveling along one or more road segments associated with a first geographic area;
identify one or more features of the historical autonomous transition data associated with the first geographic area; and
train a machine learning model based on the one or more features associated with the first geographic area.

16. The apparatus of claim 15, wherein the computer program code instructions are further configured to, when executed by the processing circuitry, cause the apparatus to:
predict autonomous transition data for a second geographic area based on the machine learning model associated with the first geographic area.

17. The apparatus of claim 15, wherein the computer program code instructions are further configured to, when executed by the processing circuitry, cause the apparatus to:
identify a feature associated with a measure of a strength of a communication signal associated with the vehicles while traveling along a road segment of the one or more road segments associated with the first geographic area; and
train the machine learning model based on the feature.

18. The apparatus of claim 15, wherein the computer program code instructions are further configured to, when executed by the processing circuitry, cause the apparatus to:
identify a feature associated with presence of a point of interest along a road segment of the one or more road segments associated with the first geographic area; and
train the machine learning model based on the feature.

19. The apparatus of claim 15, wherein the computer program code instructions are further configured to, when executed by the processing circuitry, cause the apparatus to:
identify a feature associated with a road condition for a road segment of the one or more road segments associated with the first geographic area; and
train the machine learning model based on the feature.

20. A computer-implemented method for predicting autonomous transition regions using historical information, the computer-implemented method comprising:
determining one or more features associated with one or more first vehicles traveling along a road segment associated with a first geographic area; and
predicting, using a machine learning model that receives the one or more features, whether the road segment comprises an autonomous transition area in which a particular number of vehicles are transitioned from respective autonomous levels, wherein the machine learning model is trained based on historical autonomous transition data associated with one or more second vehicles that are transitioned from respective autonomous levels while traveling along one or more road segments within a second geographic area, different than the first geographic area.
